(19) United States
(12) Patent Application Publication
(10) Pub. No.: US 2015/0120588 A1
(43) Pub. Date: Apr. 30, 2015

(54) CREATING OR UPDATING A SOCIAL NETWORK GROUP BASED ON CUSTOMER RELATIONSHIP MANAGEMENT RECORDS IN AN ENTERPRISE SOCIAL NETWORK

(71) Applicant: salesforce.com, inc., San Francisco, CA (US)

(72) Inventor: Rasmus Mencke, San Francisco, CA (US)

(21) Appl. No.: 14/515,362

(22) Filed: Oct. 15, 2014

Related U.S. Application Data
(60) Provisional application No. 61/897,356, filed on Oct. 30, 2013.
(60) Provisional application No. 62/061,809, filed on Oct. 9, 2014.

(51) Int. Cl. G06Q 50/00; G06F 17/30; H04L 29/06

(52) U.S. Cl. CPC G06Q 50/01; H04L 65/403; H04L 67/42; G06F 17/30412
USPC 705/319

(57) ABSTRACT

Disclosed are systems, methods, and computer program products for creating or updating a social network group based on customer relationship management (CRM) records in an enterprise social network. In some implementations, a server of a database system receives from a client machine a first request to create or update a social network group based on a CRM record. The server identifies one or more users associated with the CRM record and sends information identifying the users to the client machine for display. The server receives a second request in relation to creating or updating the social network group, the second request identifying a user to be included as a member of the social network group. Responsive to the second request, the server creates or updates the social network group to include the user as a member, the social network group being identified as being associated with the CRM record.

### COPYRIGHT NOTICE

A portion of the disclosure of this patent document contains material which is subject to copyright protection. The copyright owner has no objection to the facsimile reproduction by anyone of the patent document or the patent disclosure as it appears in the United States Patent and Trademark Office patent file or records but otherwise reserves all copyright rights whatsoever.

### PRIORITY DATA

This patent document claims priority to co-pending and commonly assigned U.S. Provisional Patent Application No. 61/897,356, titled “System and Method for Creating Online Social Network Groups Based on Customer Relationship Management Records,” by Mencke, filed on Oct. 30, 2013 (Attorney Docket No. 1347PROV), and to co-pending and commonly assigned U.S. Provisional Patent Application No. 62/061,809, titled “Creating or Updating a Social Network Group Based on Customer Relationship Management Records in an Enterprise Social Network,” by Mencke, filed on Oct. 9, 2014 (Attorney Docket No. 1347PROV2/SLFCP179P), which are hereby incorporated by reference in their entirety and for all purposes.

### TECHNICAL FIELD

This patent document generally relates to an enterprise social network. More specifically, this patent document discloses techniques for creating or updating social network groups based on customer relationship management records in an enterprise social network.

### BACKGROUND

“Cloud computing” services provide shared resources, applications, and information to computers and other devices upon request. In cloud computing environments, services can be provided by one or more servers accessible over the Internet rather than installing software locally on in-house computer systems. As such, users can interact with cloud computing services to undertake a wide range of tasks utilizing a diverse array of skills.

### BRIEF DESCRIPTION OF THE DRAWINGS

The included drawings are for illustrative purposes and serve only to provide examples of possible structures and operations for the disclosed inventive systems, apparatus, methods and computer program products related to creating or updating a social network group based on a customer relationship management (CRM) record in an enterprise social network. These drawings in no way limit any changes in form and detail that may be made by one skilled in the art without departing from the spirit and scope of the disclosed implementations.

FIG. 1 shows a flowchart of an example of a computer-implemented method 100 for creating or updating a social network group based on CRM records in an enterprise social network, performed in accordance with some implementations.

FIG. 2 shows a flowchart of an example of a computer-implemented method 200 for creating or updating a social network group based on CRM records in an enterprise social network, performed in accordance with some implementations.

FIG. 3 shows an example of a presentation of a social network feed in the form of a graphical user interface (GUI) as displayed on a computing device, in accordance with some implementations.

FIG. 4 shows an example of a social network feed in the form of a GUI as displayed on a computing device, in accordance with some implementations.

FIG. 5 shows an example of a presentation of a social network feed in the form of a GUI as displayed on a computing device, in accordance with some implementations.

FIG. 6 shows an example of a GUI for configuring a social network group, in accordance with some implementations.

FIG. 7 shows an example of a group feed in the form of a GUI as displayed on a computing device, in accordance with some implementations.

FIG. 8A shows a block diagram of an example of an environment 10 in which an on-demand database service can be used in accordance with some implementations.

FIG. 8B shows a block diagram of an example of some implementations of elements of FIG. 8A and various possible interconnections between these elements.

FIG. 9A shows a system diagram of an example of architectural components of an on-demand database service environment 900, in accordance with some implementations.

FIG. 9B shows a system diagram further illustrating an example of architectural components of an on-demand database service environment, in accordance with some implementations.

### DETAILED DESCRIPTION

Examples of systems, apparatus, methods and computer-readable storage media according to the disclosed implementations are described in this section. These examples are being provided solely to add context and aid in the understanding of the disclosed implementations. It will thus be apparent to one skilled in the art that implementations may be practiced without some or all of these specific details. In other instances, certain operations have not been described in detail to avoid unnecessarily obscuring implementations. Other applications are possible, such that the following examples should not be taken as definitive or limiting either in scope or setting.

In the following detailed description, references are made to the accompanying drawings, which form a part of the description and in which are shown, by way of illustration, specific implementations. Although these implementations are described in sufficient detail to enable one skilled in the art to practice the disclosed implementations, it is understood that these examples are not limiting, such that other implementations may be used and changes may be made without departing from their spirit and scope. For example, the operations of methods shown and described herein are not necessarily performed in the order indicated. It should also be understood that the methods may include more or fewer operations than are indicated. In some implementations, operations described herein as separate operations may be combined. Conversely, what may be described herein as a single operation may be implemented in multiple operations.

Some implementations of the disclosed systems, methods and computer program products relate to creating or updating a social network group based on a customer relationship management (CRM) record in an enterprise social network. By way of example, a user may use his smartphone to access and review a CRM record such as an opportunity to sell products and/or services to a potential customer. The user may have access to a database system storing CRM records in the form of opportunities, leads, accounts, cases, contacts, contracts, tasks, etc., referred to herein as a CRM system. Using conventional techniques, the user may leave the CRM system to access an enterprise social network to create an online social network group to discuss and share information about this opportunity. However, as the user is creating the social network group and providing information pertaining to the opportunity, the user may not remember all of the pertinent information about the opportunity, and may make mistakes when sharing information via the social network group, even when switching back-and-forth between display screens for the CRM system and the online social network group.

The disclosed implementations enable automatic, efficient, and accurate creation of a new social network group or updating of an existing social network group based on a CRM record, such that the group is fully populated with both data, feeds, and feed items from the CRM record used to create or update the group and any associated CRM records. Any CRM records added to the group are shared with the group members so they can view the added records and any updates from the records in the group. Also, any files added to the group will be shared with the group members as well.

In some implementations, when creating or updating the social network group, the user may be presented with one or more users, suggested by the server for inclusion as members in the social network group. These users may be identified by the server based on their relationship with the CRM record. For example, the server may identify users who are already following the CRM record. As another example, if the CRM record is a sales opportunity, the server may suggest including the entire sales team in the group. In yet another example, the server may suggest all users who have access to the CRM record. The user interface may also allow the user to search for a user of the social network to include in the group.

When creating or updating the social network group, the user may also be presented with one or more CRM records, suggested by the server for inclusion in the social network group. By way of example, the suggested records may include the parent account record for the CRM record, other opportunity records which are children of the parent account record, other opportunity records dealing with the same product, or other CRM records that are otherwise related to the CRM record. The server may identify any such related CRM records and send information identifying the related CRM records to the user's device for display to the user.

Also, when creating or updating a social network group based on a CRM record, the user may be presented with one or more files, suggested by the server for inclusion in the social network group. These files may have been previously attached to the record feed for the CRM record, or otherwise indicated as being related to the CRM record.

By identifying related users, records, and files for inclusion in the social network group, the disclosed implementations allow identification and gathering of relevant data and records for the social network group, and convenient inclusion in the social network group. The relevant data and records, and updates to the data and records, may be provided to members of the social network group via the group feed. This allows a user to quickly set up a collaborative team of users based on a CRM record and to assemble the relevant data and records.

Some but not all of the techniques described or referenced herein can be implemented in conjunction with a social networking system. Social networking systems have become a popular way to facilitate communication among people, any of whom can be recognized as users of a social networking system. One example of a social networking system is Chatter®, provided by salesforce.com, inc. of San Francisco, Calif. salesforce.com, inc. is a provider of social networking services, Customer Relationship Management (CRM) services and other database management services, any of which can be accessed and used in conjunction with the techniques disclosed herein in some implementations. These various services can be provided in a cloud computing environment, for example, in the context of a multi-tenant database system. Thus, the disclosed techniques can be implemented without having to install software locally, that is, on computing devices of users interacting with services available through the cloud. While the disclosed implementations are often described with reference to Chatter®, those skilled in the art should understand that the disclosed techniques are neither limited to Chatter® nor to any other services and systems provided by salesforce.com, inc. and can be implemented in the context of various other database systems and/or social networking systems such as Facebook®, LinkedIn®, Twitter®, Google+®, Yammer® and Jive® by way of example only.

Some social networking systems can be implemented in various settings, including organizations. For instance, a social networking system can be implemented to connect users within an enterprise such as a company or business partnership, or a group of users within such an organization. For instance, Chatter® can be used by employee users in a division of a business organization to share data, communicate, and collaborate with each other for various social purposes often involving the business of the organization. In the example of a multi-tenant database system, each organization or group within the organization can be a respective tenant of the system, as described in greater detail below.

In some social networking systems, users can access one or more social network feeds, which include information updates presented as items or entries in the feed. Such a feed item can include a single information update or a collection of individual information updates. A feed item can include various types of data including character-based data, audio data, image data and/or video data. A social network feed can be displayed in a graphical user interface (GUI) on a display device such as the display of a computing device as described below. The information updates can include various social network data from various sources and can be stored in an on-demand database service environment. In some implementations, the disclosed methods, apparatus, systems, and computer-readable storage media may be configured or designed for use in a multi-tenant database environment.

In some implementations, a social networking system may allow a user to follow data objects in the form of CRM records such as cases, accounts, or opportunities, in addition to following individual users and groups of users. The “following” of a record stored in a database, as described in greater detail below, allows a user to track the progress of that record when the user is subscribed to the record. Updates to the record, also referred to herein as changes to the record, are one type of information update that can occur and be noted on a social network feed such as a record feed or a news feed of a user subscribed to the record. Examples of record updates include field changes in the record, updates to the status of a record, as well as the creation of the record itself. Some records are publicly accessible, such that any user can follow the record, while other records are private, for which appropriate security clearance/permissions are a prerequisite to a user following the record.

Information updates can include various types of updates, which may or may not be linked with a particular record. For example, information updates can be social media communications submitted by a user or can otherwise be generated in response to user actions or in response to events. Examples of social media communications include: posts, comments, indications of a user's personal preferences such as “likes” and “dislikes”, updates to a user's status, uploaded files, and user-submitted hyperlinks to social network data or other network data such as various documents and/or web pages on the Internet. Posts can include alpha-numeric or other character-based user inputs such as words, phrases, statements, questions, emotional expressions, and/or symbols. Comments generally refer to responses to posts or to other information updates, such as words, phrases, statements, answers, questions, and reactionary emotional expressions and/or symbols. Multimedia data can be included in, linked with, or attached to a post or comment. For example, a post can include textual statements in combination with a JPEG image or animated image. A like or dislike can be submitted in response to a particular post or comment. Examples of uploaded files include presentations, documents, multimedia files, and the like.

Users can follow a record by subscribing to the record, as mentioned above. Users can also follow other entities such as other types of data objects, other users, and groups of users. Feed tracked updates regarding such entities are one type of information update that can be received and included in the user's news feed. Any number of users can follow a particular entity and thus view information updates pertaining to that entity on the users' respective news feeds. In some social networks, users may follow each other by establishing connections with each other, sometimes referred to as “friending” one another. By establishing such a connection, one user may be able to see information generated by, generated about, or otherwise associated with another user. For instance, a first user may be able to see information posted by a second user to the second user's personal social network page. One implementation of such a personal social network page is a user's profile page, for example, in the form of a web page representing the user's profile. In one example, when the first user is following the second user, the first user's news feed can receive a post from the second user submitted to the second user's profile feed. A user's profile feed is also referred to herein as the user's “wall,” which is one example of a social network feed displayed on the user's profile page.

In some implementations, a social network feed may be specific to a group of users of a social networking system. For instance, a group of users may publish a news feed. Members of the group may view and post to this group feed in accordance with a permissions configuration for the feed and the group. Information updates in a group context can also include changes to group status information.

In some implementations, when data such as posts or comments input from one or more users are submitted to a social network feed for a particular user, group, object, or other construct within a social networking system, an email notification or other type of network communication may be transmitted to all users following the user, group, or object in addition to the inclusion of the data as a feed item in one or more feeds, such as a user's profile feed, a news feed, or a record feed. In some social networking systems, the occurrence of such a notification is limited to the first instance of a published input, which may form part of a larger conversation. For instance, a notification may be transmitted for an initial post, but not for comments on the post. In some other implementations, a separate notification is transmitted for each such information update.

The term “multi-tenant database system” generally refers to those systems in which various elements of hardware and/or software of a database system may be shared by one or more customers. For example, a given application server may simultaneously process requests for a great number of customers, and a given database table may store rows of data such as feed items for a potentially much greater number of customers.

An example of a “user profile” or “user's profile” is a database object or set of objects configured to store and maintain data about a given user of a social networking system and/or database system. The data can include general information, such as name, title, phone number, a photo, a biographical summary, and a status, e.g., text describing what the user is currently doing. As mentioned below, the data can include social media communications created by other users. Where there are multiple tenants, a user is typically associated with a particular tenant. For example, a user could be a salesperson of a company, which is a tenant of the database system that provides a database service.

The term “record” generally refers to a data entity having fields with values and stored in database system. An example of a record is an instance of a data object created by a user of the database service, for example, in the form of a CRM record about a particular (actual or potential) business relationship or project. The record can have a data structure defined by the database service (a standard object) or defined by a user (custom object). For example, a record can be for a business partner or potential business partner (e.g., a client, vendor, distributor, etc.) of the user, and can include information describing an entire company, subsidiaries, or contacts at the company. As another example, a record can be a project that the user is working on, such as an opportunity (e.g., a possible sale) with an existing partner, or a project that the user is trying to get. In one implementation of a multi-tenant database system, each record for the tenants has a unique identifier stored in a common table. A record has data fields that are defined by the structure of the object (e.g., fields of certain data types and purposes). A record can also have custom fields defined by a user. A field can be another record or include links thereto, thereby providing a parent-child relationship between the records.

The terms “social network feed” and “feed” are used interchangeably herein and generally refer to a combination (e.g., a list) of feed items or entries with various types of information and data. Such feed items can be stored and maintained in one or more database tables, e.g., as rows in the table(s), that can be accessed to retrieve relevant information to be presented as part of a displayed feed. The term “feed item” (or feed element) generally refers to an item of information, which can be presented in the feed such as a post submitted by a user. Feed items of information about a user can be presented in a user's profile feed of the database, while feed items of information about a record can be presented in a record feed in the database, by way of example. A profile feed and a record feed are examples of different types of social network feeds. A second user following a first user and a record can receive the feed items associated with the first user and the record for display in the second user's news feed, which is another type of social network feed. In some implementations, the feed items from any number of followed users and records can be combined into a single social network feed of a particular user.

As examples, a feed item can be a social media communication, such as a user-generated post of text data, and a feed tracked update to a record or profile, such as a change to a field of the record. Feed tracked updates are described in greater detail below. A feed can be a combination of social media communications and feed tracked updates. Social media communications include text created by a user, and may include other data as well. Examples of social media communications include posts, user status updates, and comments. Social media communications can be created for a user's profile or for a record. Posts can be created by various users, potentially any user, although some restrictions can be applied. As an example, posts can be made to a wall section of a user's profile page (which can include a number of recent posts) or a section of a record that includes multiple posts. The posts can be organized in chronological order when displayed in a GUI, for instance, on the user's profile page, as part of the user's profile feed. In contrast to a post, a user status update changes a status of a user and can be made by that user or an administrator. A record can also have a status, the update of which can be provided by an owner of the record or other users having suitable write access permissions to the record. The owner can be a single user, multiple users, or a group.

In some implementations, a comment can be made on any feed item. In some implementations, comments are organized as a list explicitly tied to a particular feed tracked update, post, or status update. In some implementations, comments may not be listed in the first layer (in a hierarchal sense) of feed items, but listed as a second layer branching from a particular first layer feed item.

A “feed tracked update,” also referred to herein as a “feed update,” is one type of information update and generally refers to data representing an event. A feed tracked update can include text generated by the database system in response to the event, to be provided as one or more feed items for possible inclusion in one or more feeds. In one implementation, the data can initially be stored, and then the database system can later use the data to create text for describing the event. Both the data and/or the text can be a feed tracked update, as used herein. In various implementations, an event can be an update of a record and/or can be triggered by a specific action by a user. Which actions trigger an event can be configurable. Which events have feed tracked updates created and which feed updates are sent to which users can also be configurable. Social media communications and other types of feed updates can be stored as a field or child object of the record. For example, the feed can be stored as a child object of the record.

A “group” is generally a collection of users. In some implementations, the group may be defined as users with a same or similar attribute, or by membership. In some implementations, a “group feed”, also referred to herein as a “group news feed”, includes one or more feed items about any user in the group. In some implementations, the group feed also includes information updates and other feed items that are about the group as a whole, the group's purpose, the group's description, and group records and other objects stored in association with the group. Threads of information updates including group record updates and social media communications, such as posts, comments, likes, etc., can define group conversations and change over time.

An “entity feed” or “record feed” generally refers to a feed of feed items about a particular record in the database. Such feed items can include feed tracked updates about changes to the record and posts made by users about the record. An entity feed can be composed of any type of feed item. Such a feed can be displayed on a page such as a web page associated with the record, e.g., a home page of the record. As used herein, a “profile feed” or “user's profile feed” generally refers to a feed of feed items about a particular user. In one example, the feed items for a profile feed include posts and comments that other users make about or send to the particular user, and status updates made by the particular user. Such a profile feed can be displayed on a page associated with the particular user. In another example, feed items in a profile feed could include posts made by the particular user and feed tracked updates initiated based on actions of the particular user.

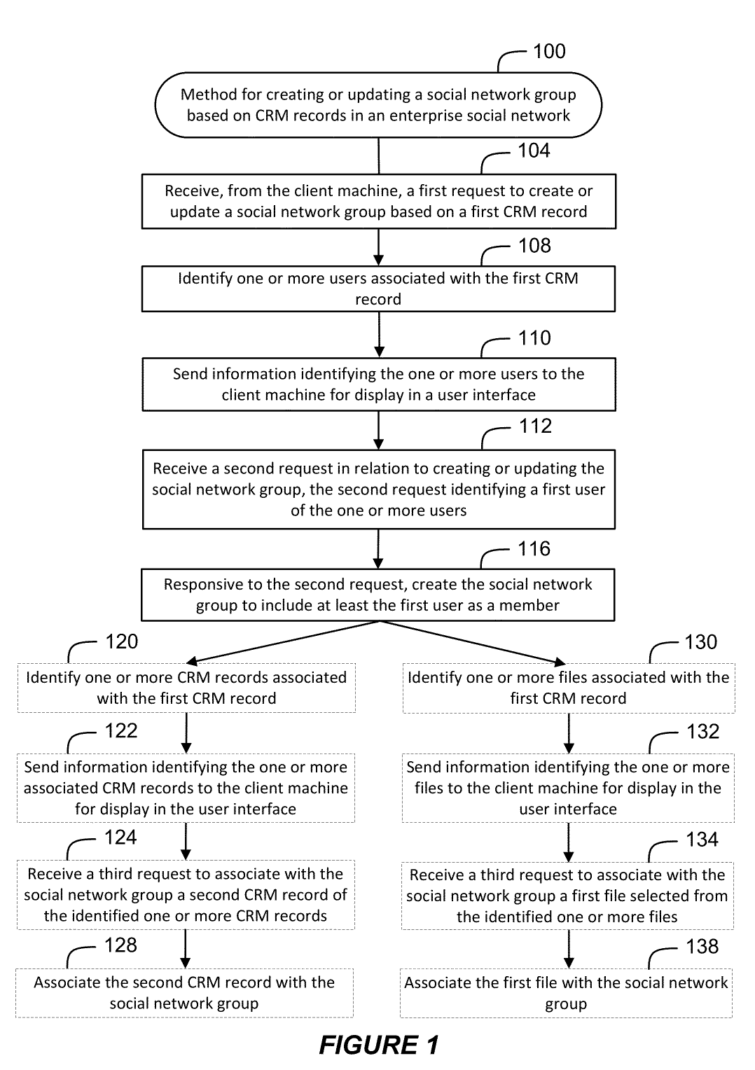

FIG. 1 shows a flowchart of an example of a computer-implemented method 100 for creating or updating a social network group based on CRM records in an enterprise social network, performed in accordance with some implementations.

In FIG. 1, at block 104, a server of a database system hosting an enterprise social network receives, from a client machine, a first request to create or update a social network group based on a first CRM record. The first CRM record may be stored as a data object in the database system. The database system may host an enterprise social network, such as Chatter, in which users may share information and collaborate. The client machine may include a display device configured to display a user interface for the enterprise social network. A user of the enterprise social network may be presented with a social network feed in which the user may receive updates from other users, compose messages, and access CRM record data. The database system may store a number of CRM records, such as accounts, opportunities, leads, contacts, etc. that users of the enterprise social network can view, edit, and follow in one or more social network feeds. In some implementations, the request received from the client machine identifies the first CRM record on which the social network group is to be based.

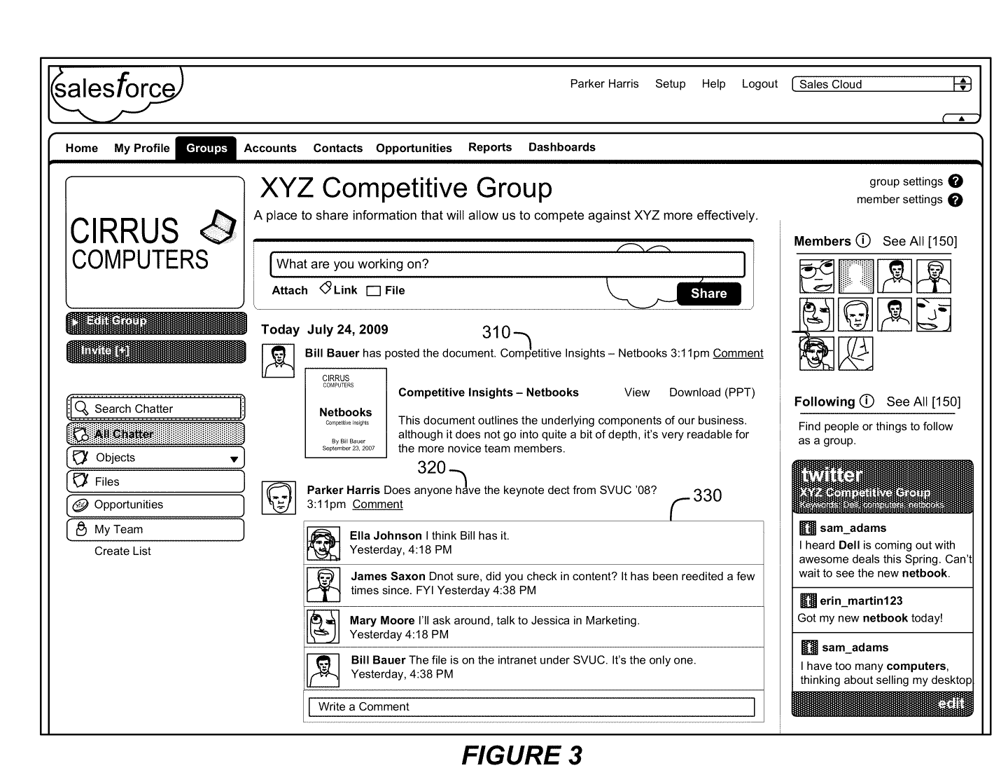

FIG. 3 shows an example of a presentation of a social network feed in the form of a graphical user interface (GUI) as displayed on a computing device, in accordance with some implementations. As shown, a feed item 310 shows that a user has posted a document to the group feed. The text “Bill Bauer has posted the document Competitive Insights” may be generated by the database system in response to a record being changed. A feed item 320 shows a post to the group, along with comments 330 from Ella Johnson, James Saxon, Mary Moore and Bill Bauer.

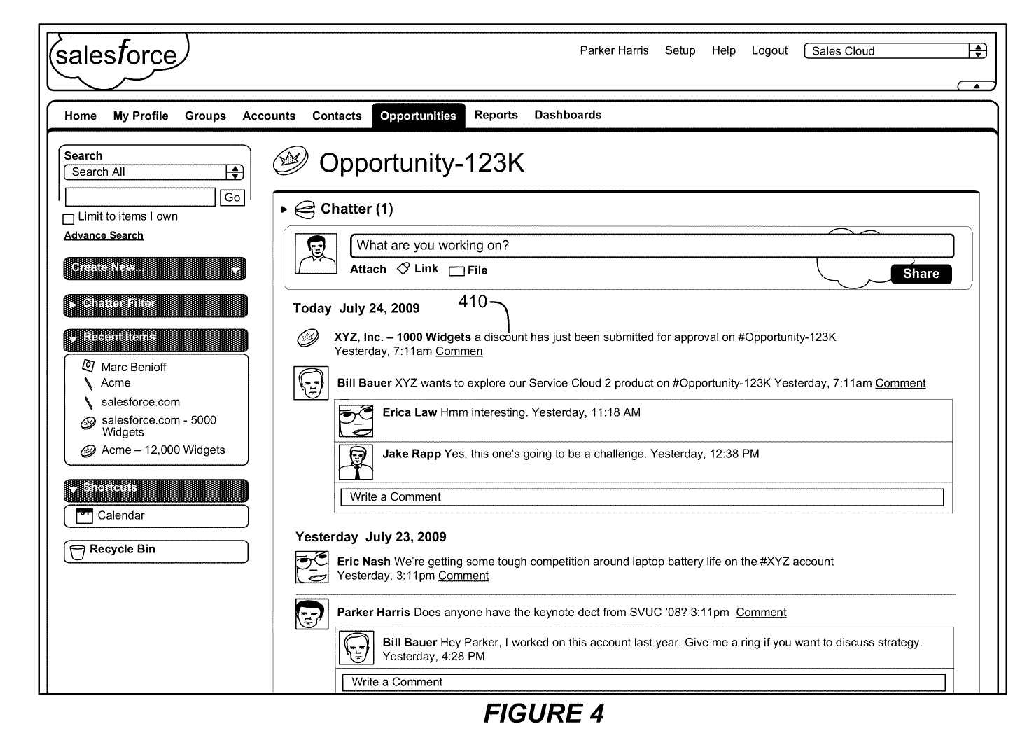

FIG. 4 shows an example of a social network feed in the form of a GUI as displayed on a computing device, in accordance with some implementations. In this example, the social network feed is in the form of a record feed on a record profile page for the “Opportunity-123K” record stored in a database system. The record feed includes a feed-tracked update, a post, and comments. Feed item 410 shows a feed-tracked update based on the event of submitting a discount for approval. Other feed items include posts, for example, from Bill Bauer, made to the record and comments, for example, from Erica Law and Jake Rapp, submitted in response to the posts.

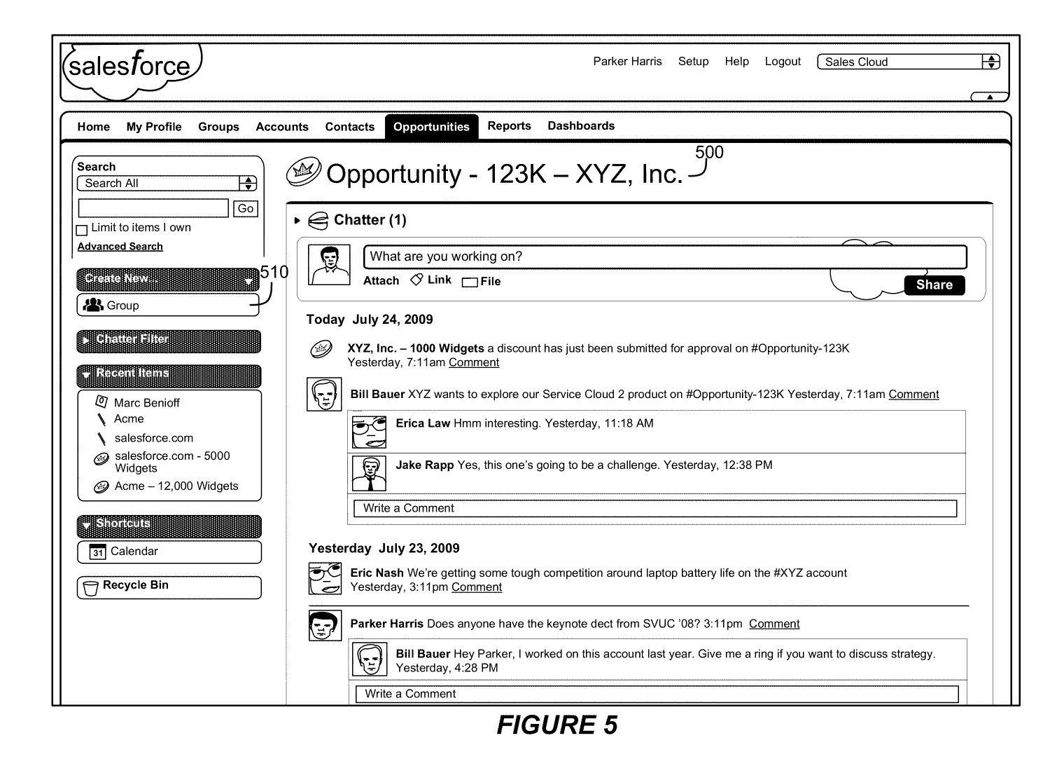

FIG. 5 shows an example of a presentation of a social network feed in the form of a GUI as displayed on a computing device, in accordance with some implementations. In this example, the social network feed is in the form of a record feed for the “Opportunity-123K-XYZ, Inc.” opportunity record 500 stored in the database system. As in FIG. 4, the record feed includes feed-tracked updates to the opportunity record, posts, and comments. A user viewing the user interface of FIG. 5 may be browsing the opportunity feed for the “Opportunity-123K-XYZ, Inc.” opportunity. While there are some users who are following the opportunity record and writing posts and making changes to the record, the user may decide that it would be helpful to have a Chatter group for the various users to collaborate on this particular opportunity, to include other users and other related opportunities or accounts in the group. As such, the user may want to quickly create a Chatter group based on this opportunity and select users to include in the group, other CRM records for the group to follow, and files to associate with the group.

The sidebar of the record feed includes an option 510 to create a new social network group based on the opportunity record. A user may click on the Create New Group option 510 to send a request to the server to create a social network group based on the “Opportunity-123K-XYZ, Inc.” record.

In some implementations, the record feed may also include an option to update a social network group to include the opportunity record. A user may click on an Update Group option to send a request to the server to update a social network group to include the “Opportunity-123 K-XYZ, Inc.” record.

In some implementations, in order to identify the CRM record that the new social network group should be based on, the server may determine which CRM record is being displayed in the user interface of the client machine when the request is submitted by the client machine. For example, in FIG. 5, because the user interface is displaying the “Opportunity-123K-XYZ, Inc.” opportunity record, the request may automatically identify this opportunity record as the CRM record on which the new social network group should be based.

In FIG. 1, at block 108, the server identifies one or more users associated with the first CRM record. In response to the user's request to create or update a social network group based on the CRM record, the server may identify a set of users who the user may wish to include in the new social network group. The set of users may include the users who are currently following or commenting on the CRM record. In the example of FIG. 5, the server may include Bill Bauer, Erica Law, Jake Rapp, Eric Nash, and Parker Harris in this set of users to present to the user. In some implementations, the set of users may include all users who have access to the CRM record. For example, if the CRM record is a sales opportunity, the set of users may include the entire sales team. In some implementations, the set of users may include the user who created the CRM record in the first place or has ownership of the CRM record. In some implementations, the set of users may also include users who are experts regarding a topic associated with the CRM record. As an example, if the opportunity has to do with selling widgets, the server may identify users who are widget experts and present these users to the user requesting the social network group.

In FIG. 1, at block 110, the server sends information identifying the one or more users to the client machine for display in a user interface on a display of the client machine. The identified one or more users may be presented to the user in the user interface of the client machine for the user to select from. The user may select some or all of the presented users to include in the new social network group.

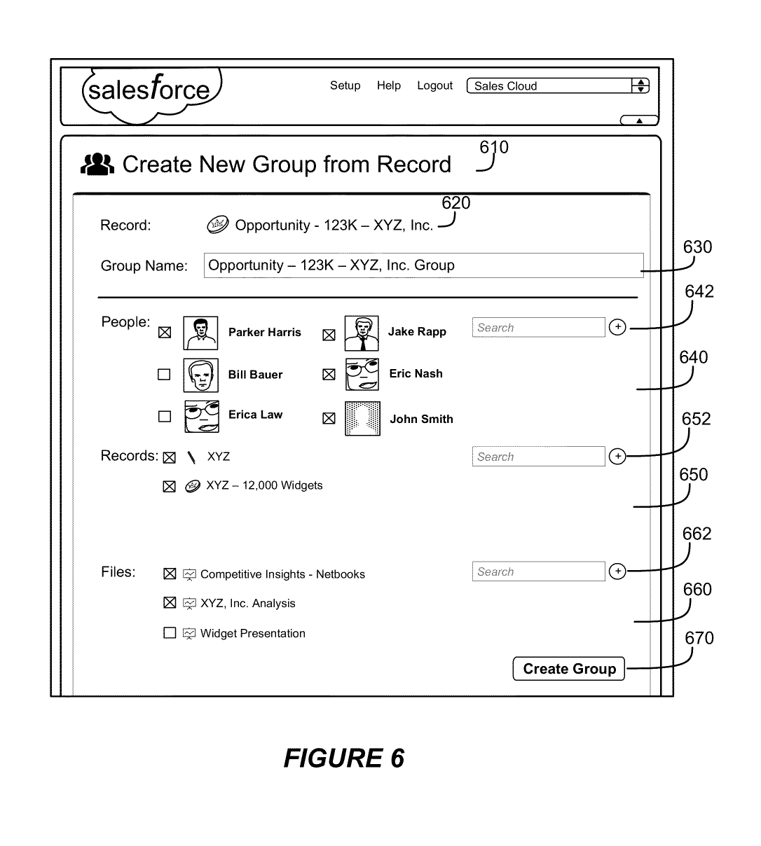

FIG. 6 shows an example of a GUI 610 for configuring a social network group, in accordance with some implementations. In this example, the user interface is presented to the user in response to the user's request to create a new group or update an existing group based on the opportunity record. The user interface identifies the record 620 that the new group is based on. The user interface also includes a prompt 630 for the user to enter a name for the new group. The user interface may also include list of suggested users 640 that the user may select to include in the new group. The list of suggested users 640 is identified by the server as being related to the opportunity record on which the new group is based. As described above, the list 640 may include users who are currently following the record, users who have commented on the record, users who have access to the record, the user who created the record, and/or users who are experts in a topic related to the record. The user interface also includes a user field 642 that the user may use to search for another user who is not presented in the list 640 to include in the new group. The user may search for the user by name or by any of the attributes of the user, such as email address, user identifier, etc. The user interface also includes a Create Group button 670 that the user may use to submit a request to the server to create the group with all of the selections provided by the user.

In FIG. 1, at block 112, the server receives a second request in relation to creating or updating the social network group. The second request may identify at least a first user selected from the one or more users to be included as a member of the social network group. Returning to the example of FIG. 6, once the user clicks on the Create Group button 670, the second request is transmitted to the server to create the social network group. The second request identifies the users who were selected by the user in the user interface of FIG. 6. In this example, the identified users are Parker Harris, Jake Rapp, Eric Nash, and John Smith. The request received by the server identifies these four users to include in the newly create social network group. In some implementations, the one or more users may be identified automatically based on a default set of users.

In FIG. 1, at block 116, the server creates or updates the social network group to include at least the first user as a member. The social network group may be identified by one or more data objects in the database system as being associated with the first CRM record. In some implementations, the social network group is configured to follow the first CRM record such that updates to the first CRM record appear as feed items in a group feed for the social network group. The newly created social network group also includes the identified one or more users as members.

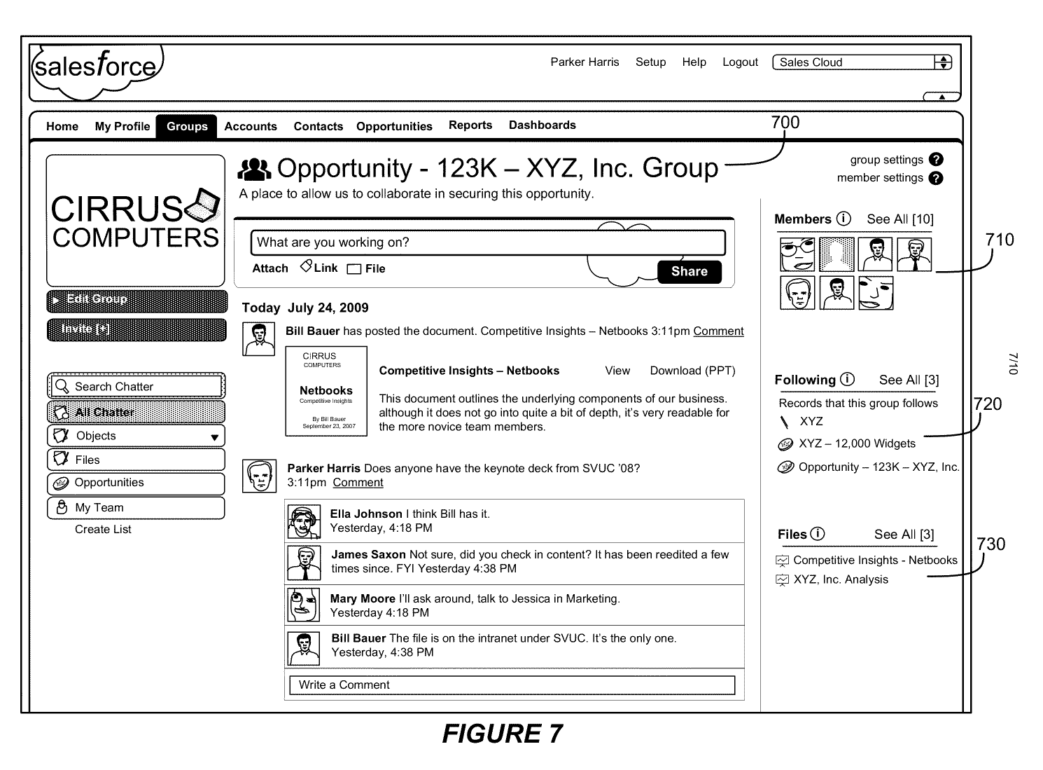

FIG. 7 shows an example of a group feed 700 in the form of a GUI as displayed on a computing device, in accordance with some implementations. As an example, the user interface of FIG. 7 presents the group feed for the newly created social network group “Opportunity-123K-XYZ, Inc. Group.” The sidebar of the user interface includes a member list 710 of the users who were included as members of the new group.

In FIG. 1, at block 120, the server identifies one or more CRM records of the database system associated with the first CRM record. Returning to the example of FIG. 6, when the user requests to create a new group based on the “Opportunity-123K-XYZ, Inc.” opportunity record 620, the server presents the user interface of FIG. 6. The user interface includes a list of CRM records 650 that are identified by the server as related to the opportunity record 620. In some implementations, the second CRM record may be associated with the first CRM record in a child-parent or a parent-child relationship in a hierarchical data model. In some implementations, the first CRM record may be an account, and the second CRM record may be an opportunity, a lead, a case, a contact, or a task associated with the account.

In FIG. 1, at block 122, the server sends information identifying the one or more associated CRM records to the client machine for display in the user interface. In some implementations, as illustrated in FIG. 6, the server may identify a parent account, one or more products, open activities, orders, etc. or any other information and records related to the opportunity record 620, and display them in the list 650. As an example, the list 650 may include a record that is a parent record of the opportunity record 620, such as the XYZ account record. The list 650 may also include other opportunity records that are associated with the same account, such as the “XYZ-12,000 Widgets” opportunity record. As another example, the list could also include widget products. The user interface may also include a record field 652 that the user may use to search for another CRM record that is not presented in the list 650 to include in the new group. The user may search for the CRM record by name or by any of the attributes of the CRM record.

In FIG. 1, at block 124, the server receives a third request to associate with the social network group a second CRM record selected from the identified one or more CRM records. In FIG. 6, when the user clicks on “Create Group” 670, the request to create the new social network group is submitted to the server, and any selected CRM records from the list of CRM record 650 are identified in the request to the server.

In FIG. 1, at block 128, the server associates the second CRM record with the social network group. In some implementations, updates to the second CRM record may be published as feed items in a group feed associated with the social network group, and the group feed may be accessible to the members of the social network group. In FIG. 6, the server may associate both the XYZ account record and the 12,000 Widgets opportunity record with the new social network group, such that updates to the XYZ account record and the 12,000 Widgets opportunity record are displayed to the members of the social network group.

In FIG. 7, the user interface presents the group feed for the newly created social network group. The sidebar of the user interface includes a “Following” list 720 that includes all of the CRM records that the group is following. The CRM records that were identified in the request to the server to create the social network group may all appear in this “Following” list 720. As an example, when an update is made to the XYZ account record, the update may appear in the group feed 700 as a feed item for members of the group to view.

In FIG. 1, at block 130, the server identifies one or more files of the database system that are associated with the first CRM record. In some implementations, the one or more files may be attached to feed items of a record feed associated with the first CRM record.

In FIG. 1, at block 132, the server sends information identifying the one or more files to the client machine for display in the user interface. Returning to the example of FIG. 6, when the user requests to create a new group based on the “Opportunity-123K-XYZ, Inc.” opportunity record 620, the server presents the user interface of FIG. 6. The user interface includes a list of files 660 that are identified by the server as related to the opportunity record 620. In some implementations, the server may identify files that were previously attached to feed items of a record feed associated with the opportunity record. For example, the opportunity record may be associated with a record feed accessible to users following the opportunity record. One or more users may have attached files to feed items of the record feed. These files may be identified by the server and displayed by the client machine in the list 660 of the user interface. In FIG. 6, the list 660 includes three files, two of which are selected, “Competitive Insights-Netbooks” and “XYZ Inc. Analysis.” The list 660 may also include files that are associated with CRM records related to the CRM record that the social network group is based on. The user interface may also include a file field 662 that the user may use to search for another file that is not presented in the list 660 to include in the new group. The user may search for the file by name or by any of the attributes of the file.

In FIG. 1, at block 134, the server receives a third request to associate with the social network group a first file selected from the identified one or more files. In FIG. 6, when the user clicks on “Create Group” 670, the request to create the new social network group is submitted to the server, and any selected files from the list of files 660 are identified in the request to the server.

In FIG. 1, at block 138, the server associates the first file with the social network group. In FIG. 6, the server may associate both the “Competitive Insights-Netbooks” and “XYZ, Inc. Analysis” files with the new social network group, such that updates to the files are displayed to the members of the social network group. In some implementations, updates to the first file may be published as feed items in a group feed associated with the social network group, and the group feed may be accessible to the members of the social network group.

In FIG. 7, the user interface presents the group feed for the newly created social network group. The sidebar of the user interface includes a “Files” list 730 that includes all of the files that are associated with the social network group. The files that were identified in the request to the server to create the social network group may all appear in this “Files” list 730. As an example, when an update is made to the “Competitive Insights-Netbooks” file, the update may appear in the group feed 700 as a feed item for members of the group to view.

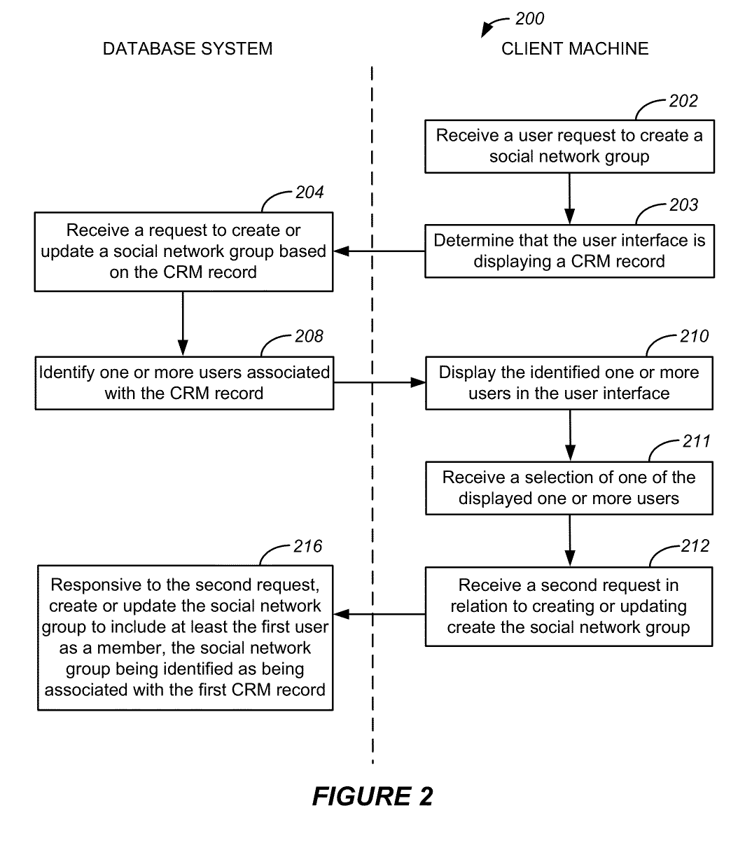

FIG. 2 shows a flowchart of an example of a computer-implemented method 200 for creating a social network group based on CRM records in an enterprise social network, performed in accordance with some implementations.

In FIG. 2, at block 202, a client machine comprising a storage medium and a display configured to display a user interface for an enterprise social network receives a user request to create a social network group. Returning to FIG. 5, a user of the client machine may submit the request to the client machine to create the social network group by clicking on the create new group button 510 of the user interface.

In FIG. 2, at block 203, the client machine determines that the user interface is displaying a CRM record. In some implementations, the client machine may determine that the social network group be created based on the CRM record that is displayed in the user interface at the time that the request to create the social network group is received.

In FIG. 2, at block 204, a server of a database system in communication with the client machine and configured to host an enterprise social network receives a request to create a social network group based on the CRM record, as generally described in block 104 of FIG. 1.

In FIG. 2, at block 208, the server identifies one or more users associated with the CRM record, as generally described in block 108 of FIG. 1.

In FIG. 2, at block 210, the client machine displays the identified one or more users in the user interface. The users identified by the server as associated with the CRM record are provided to the client machine to display to the user, as in the example of FIG. 6.

In FIG. 2, at block 211, the client machine receives a selection of one of the displayed one or more users. Returning to FIG. 6, the users viewing the user interface at the client machine may select one or more of the users in the user list 640 for inclusion in the social network group.

In FIG. 2, at block 212, the client machine receives a request to create the social network group, wherein the selected user is included as a member of the social network group. In FIG. 6, the user may submit this request by clicking on the create group button 670, and the request may be transmitted to the server and handled as generally described in block 112 of FIG. 1.

In FIG. 2, at block 216, the server creates the social network group, as generally described in block 116 of FIG. 1.

Systems, apparatus, and methods are described below for implementing database systems and enterprise level social and business information networking systems in conjunction with the disclosed techniques. Such implementations can provide more efficient use of a database system. For instance, a user of a database system may not easily know when important information in the database has changed, e.g., about a project or client. Such implementations can provide feed tracked updates about such changes and other events, thereby keeping users informed.

By way of example, a user can update a record in the form of a CRM object, e.g., an opportunity such as a possible sale of 1000 computers. Once the record update has been made, a feed tracked update about the record update can then automatically be provided, e.g., in a feed, to anyone subscribing to the opportunity or to the user. Thus, the user does not need to contact a manager regarding the change in the opportunity, since the feed tracked update about the update is sent via a feed to the manager's feed page or other page.

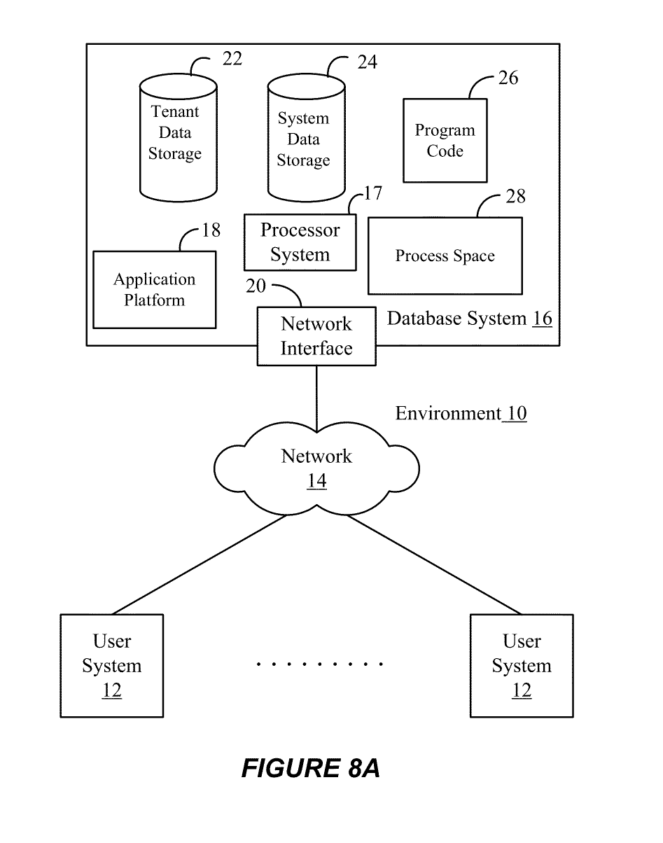

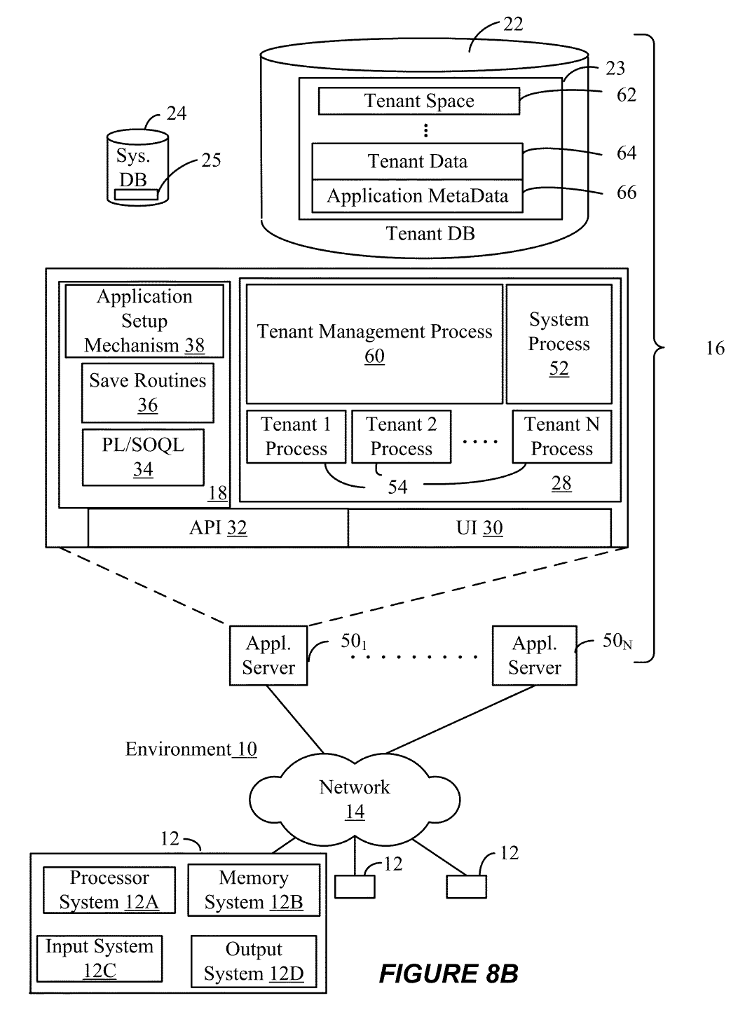

FIG. 8A shows a block diagram of an example of an environment 10 in which an on-demand database service exists and can be used in accordance with some implementations. Environment 10 may include user systems 12, network 14, database system 16, processor system 17, application platform 18, network interface 20, tenant data storage 22, system data storage 24, program code 26, and process space 28. In other implementations, environment 10 may not have all of these components and/or may have other components instead of, or in addition to, those listed above.

A user system 12 may be implemented as any computing device(s) or other data processing apparatus such as a machine or system used by a user to access a database system 16. For example, any of user systems 12 can be a handheld and/or portable computing device such as a mobile phone, a smartphone, a laptop computer, or a tablet. Other examples of a user system include computing devices such as a work station and/or a network of computing devices. As illustrated in FIG. 8A (and in more detail in FIG. 8B) user systems 12 might interact via a network 14 with an on-demand database service, which is implemented in the example of FIG. 8A as database system 16.

An on-demand database service, implemented using system 16 by way of example, is a service that is made available to users who do not need to necessarily be concerned with building and/or maintaining the database system. Instead, the database system may be available for their use when the users need the database system, i.e., on the demand of the users. Some on-demand database services may store information from one or more tenants into tables of a common database image to form a multi-tenant database system (MTS). A database image may include one or more database objects. A relational database management system (RDBMS) or the equivalent may execute storage and retrieval of information against the database object(s). Application platform 18 may be a framework that allows the applications of system 16 to run, such as the hardware and/or software, e.g., the operating system. In some implementations, application platform 18 enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities, and the capacity of a particular user system 12 might be entirely determined by permissions (permission levels) for the current user. For example, when a salesperson is using a particular user system 12 to interact with system 16, the user system has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level, also called authorization.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. Network 14 can include a TCP/IP (Transfer Control Protocol and Internet Protocol) network, such as the global internetwork of networks often referred to as the Internet. The Internet will be used in many of the examples herein. However, it should be understood that the networks that the present implementations might use are not so limited.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP signals to and from an HTTP server at system 16. Such an HTTP server might be implemented as the sole network interface 20 between system 16 and network 14, but other techniques might be used as well or instead. In some implementations, the network interface 20 between system 16 and network 14 includes load sharing functionality, such as round-robin HTTP request distributors to balance loads and distribute incoming HTTP requests evenly over a plurality of servers. At least for users accessing system 16, each of the plurality of servers has access to the MTS' data; however, other alternative configurations may be used instead.

In one implementation, system 16, shown in FIG. 8A, implements a web-based CRM system. For example, in one implementation, system 16 includes application servers configured to implement and execute CRM software applications as well as provide related data, code, forms, web pages and other information to and from user systems 12 and to store to, and retrieve from, a database system related data, objects, and Webpage content. With a multi-tenant system, data for multiple tenants may be stored in the same physical database object in tenant data storage 22, however, tenant data typically is arranged in the storage medium(s) of tenant data storage 22 so that data of one tenant is kept logically separate from that of other tenants so that one tenant does not have access to another tenant's data, unless such data is expressly shared. In certain implementations, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

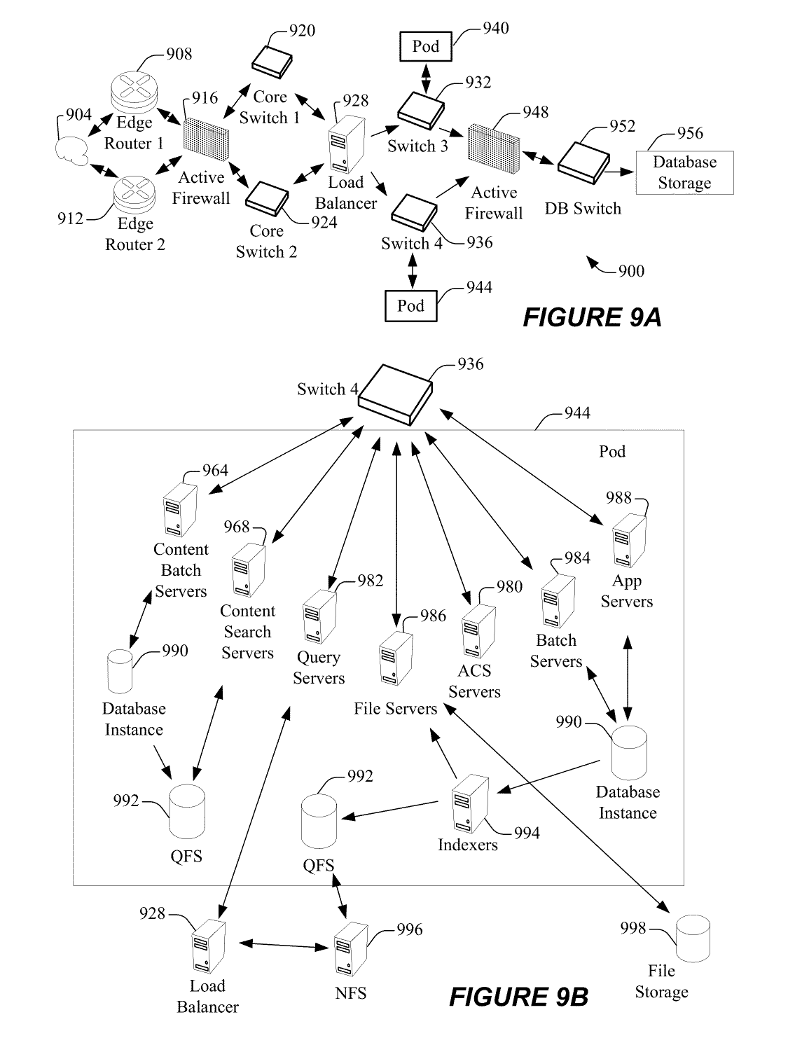

One arrangement for elements of system 16 is shown in FIGS. 9A and 9B, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 8A include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. The term “computing device” is also referred to herein simply as a “computer”. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user input devices, such as a keyboard, a mouse, trackball, touch pad, touch screen, pen or the like, for interacting with a GUI provided by the browser on a display (e.g., a monitor screen, LCD display, OLED display, etc.) of the computing device in conjunction with pages, forms, applications and other information provided by system 16 or other systems or servers. Thus, “display device” as used herein can refer to a display of a computer system such as a monitor or touch-screen display, and can refer to any computing device having display capabilities such as a desktop computer, laptop, tablet, smartphone, a television set-top box, or wearable device such Google Glass® or other human body-mounted display apparatus. For example, the display device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to one implementation, each user system 12 and all of its components are operator configurable using applications, such as a browser, including computer code run using a central processing unit such as an Intel Pentium® processor or the like. Similarly, system 16 (and additional instances of an MTS, where more than one is present) and all of its components might be operator configurable using application(s) including computer code to run using processor system 17, which may be implemented to include a central processing unit, which may include an Intel Pentium® processor or the like, and/or multiple processor units. Non-transitory computer-readable media can have instructions stored thereon/in, that can be executed by or used to program a computing device to perform any of the methods of the implementations described herein. Computer program code 26 implementing instructions for operating and configuring system 16 to intercommunicate and to process web pages, applications and other data and media content as described herein is preferably downloadable and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any other type of computer-readable medium or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for the disclosed implementations can be realized in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to refer to one type of computing device such as a system including processing hardware and process space(s), an associated storage medium such as a memory device or database, and, in some instances, a database application (e.g., OODBMS or RDBMS) as is well known in the art. It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

FIG. 8B shows a block diagram of an example of some implementations of elements of FIG. 8A and various possible interconnections between these elements. That is, FIG. 8B also illustrates environment 10. However, in FIG. 8B elements of system 16 and various interconnections in some implementations are further illustrated. FIG. 8B shows that user system 12 may include processor system 12A, memory system 12B, input system 12C, and output system 12D. FIG. 8B shows network 14 and system 16. FIG. 8B also shows that system 16 may include tenant data storage 22, tenant data 23, system data storage 24, system data 25, User Interface (UI) 30, Application Program Interface (API) 32, PL/SOQL 34, save routines 36, application setup mechanism 38, application servers 50₁-50_{N}, system process space 52, tenant process spaces 54, tenant management process space 60, tenant storage space 62, user storage 64, and application metadata 66. In other implementations, environment 10 may not have the same elements as those listed above and/or may have other elements instead of, or in addition to, those listed above.

User system 12, network 14, system 16, tenant data storage 22, and system data storage 24 were discussed above in FIG. 8A. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 8B, system 16 may include a network interface 20 (of FIG. 8A) implemented as a set of application servers 50, an application platform 18, tenant data storage 22, and system data storage 24. Also shown is system process space 52, including individual tenant process spaces 54 and a tenant management process space 60. Each application server 50 may be configured to communicate with tenant data storage 22 and the tenant data 23 therein, and system data storage 24 and the system data 25 therein to serve requests of user systems 12. The tenant data 23 might be divided into individual tenant storage spaces 62, which can be either a physical arrangement and/or a logical arrangement of data. Within each tenant storage space 62, user storage 64 and application metadata 66 might be similarly allocated for each user. For example, a copy of a user's most recently used (MRU) items might be stored to user storage 64. Similarly, a copy of MRU items for an entire organization that is a tenant might be stored to tenant storage space 62. A UI 30 provides a user interface and an API 32 provides an application programmer interface to system 16 resident processes to users and/or developers at user systems 12. The tenant data and the system data may be stored in various databases, such as one or more Oracle® databases.

Application platform 18 includes an application setup mechanism 38 that supports application developers' creation and management of applications, which may be saved as metadata into tenant data storage 22 by save routines 36 for execution by subscribers as one or more tenant process spaces 54 managed by tenant management process 60 for example.

Invocations to such applications may be coded using PL/SOQL 34 that provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes, which manage retrieving application metadata 66 for the subscriber making the invocation and executing the metadata as an application in a virtual machine.

Each application server 50 may be communicably coupled to database systems, e.g., having access to system data 25 and tenant data 23, via a different network connection. For example, one application server 50₁ might be coupled via the network 14 (e.g., the Internet), another application server 50_{N-1} might be coupled via a direct network link, and another application server 50_{N} might be coupled by yet a different network connection. Transfer Control Protocol and Internet Protocol (TCP/IP) are typical protocols for communicating between application servers 50 and the database system. However, it will be apparent to one skilled in the art that other transport protocols may be used to optimize the system depending on the network interconnect used.

In certain implementations, each application server 50 is configured to handle requests for any user associated with any organization that is a tenant. Because it is desirable to be able to add and remove application servers from the server pool at any time for any reason, there is preferably no server affinity for a user and/or organization to a specific application server 50. In one implementation, therefore, an interface system implementing a load balancing function (e.g., an F5 Big-IP load balancer) is communicably coupled between the application servers 50 and the user systems 12 to distribute requests to the application servers 50. In one implementation, the load balancer uses a least connections algorithm to route user requests to the application servers 50. Other examples of load balancing algorithms, such as round robin and observed response time, also can be used. For example, in certain implementations, three consecutive requests from the same user could hit three different application servers 50, and three requests from different users could hit the same application server 50. In this manner, by way of example, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain implementations, user systems 12 (which may be client systems) communicate with application servers 50 to request and update system-level and tenant-level data from system 16 that may involve sending one or more queries to tenant data storage 22 and/or system data storage 24. System 16 (e.g., an application server 50 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In certain implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

FIG. 9A shows a system diagram of an example of architectural components of an on-demand database service environment 900, in accordance with some implementations. A client machine located in the cloud 904, generally referring to one or more networks in combination, as described herein, may communicate with the on-demand database service environment via one or more edge routers 908 and 912. A client machine can be any of the examples of user systems 12 described above. The edge routers may communicate with one or more core switches 920 and 924 via firewall 916. The core switches may communicate with a load balancer 928, which may distribute server load over different pods, such as the pods 940 and 944. The pods 940 and 944, which may each include one or more servers and/or other computing resources, may perform data processing and other operations used to provide on-demand services. Communication with the pods may be conducted via pod switches 932 and 936. Components of the on-demand database service environment may communicate with a database storage 956 via a database firewall 948 and a database switch 952.

As shown in FIGS. 9A and 9B, accessing an on-demand database service environment may involve communications transmitted among a variety of different hardware and/or software components. Further, the on-demand database service environment 900 is a simplified representation of an actual on-demand database service environment. For example, while only one or two devices of each type are shown in FIGS. 9A and 9B, some implementations of an on-demand database service environment may include anywhere from one to many devices of each type. Also, the on-demand database service environment need not include each device shown in FIGS. 9A and 9B, or may include additional devices not shown in FIGS. 9A and 9B.

Moreover, one or more of the devices in the on-demand database service environment 900 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 904 is intended to refer to a data network or combination of data networks, often including the Internet. Client machines located in the cloud 904 may communicate with the on-demand database service environment to access services provided by the on-demand database service environment. For example, client machines may access the on-demand database service environment to retrieve, store, edit, and/or process information.

In some implementations, the edge routers 908 and 912 route packets between the cloud 904 and other components of the on-demand database service environment 900. The edge routers 908 and 912 may employ the Border Gateway Protocol (BGP). The BGP is the core routing protocol of the Internet. The edge routers 908 and 912 may maintain a table of IP networks or ‘prefixes’, which designate network reachability among autonomous systems on the Internet.

In one or more implementations, the firewall 916 may protect the inner components of the on-demand database service environment 900 from Internet traffic. The firewall 916 may block, permit, or deny access to the inner components of the on-demand database service environment 900 based upon a set of rules and other criteria. The firewall 916 may act as one or more of a packet filter, an application gateway, a stateful filter, a proxy server, or any other type of firewall.

In some implementations, the core switches 920 and 924 are high-capacity switches that transfer packets within the on-demand database service environment 900. The core switches 920 and 924 may be configured as network bridges that quickly route data between different components within the on-demand database service environment. In some implementations, the use of two or more core switches 920 and 924 may provide redundancy and/or reduced latency.

In some implementations, the pods 940 and 944 may perform the core data processing and service functions provided by the on-demand database service environment. Each pod may include various types of hardware and/or software computing resources. An example of the pod architecture is discussed in greater detail with reference to FIG. 9B.

In some implementations, communication between the pods 940 and 944 may be conducted via the pod switches 932 and 936. The pod switches 932 and 936 may facilitate communication between the pods 940 and 944 and client machines located in the cloud 904, for example via core switches 920 and 924. Also, the pod switches 932 and 936 may facilitate communication between the pods 940 and 944 and the database storage 956.

In some implementations, the load balancer 928 may distribute workload between the pods 940 and 944. Balancing the on-demand service requests between the pods may assist in improving the use of resources, increasing throughput, reducing response times, and/or reducing overhead. The load balancer 928 may include multilayer switches to analyze and forward traffic.

In some implementations, access to the database storage 956 may be guarded by a database firewall 948. The database firewall 948 may act as a computer application firewall operating at the database application layer of a protocol stack. The database firewall 948 may protect the database storage 956 from application attacks such as structure query language (SQL) injection, database rootkits, and unauthorized information disclosure.

In some implementations, the database firewall 948 may include a host using one or more forms of reverse proxy services to proxy traffic before passing it to a gateway router. The database firewall 948 may inspect the contents of database traffic and block certain content or database requests. The database firewall 948 may work on the SQL application level atop the TCP/IP stack, managing applications' connection to the database or SQL management interfaces as well as intercepting and enforcing packets traveling to or from a database network or application interface.

In some implementations, communication with the database storage 956 may be conducted via the database switch 952. The multi-tenant database storage 956 may include more than one hardware and/or software components for handling database queries. Accordingly, the database switch 952 may direct database queries transmitted by other components of the on-demand database service environment (e.g., the pods 940 and 944) to the correct components within the database storage 956.

In some implementations, the database storage 956 is an on-demand database system shared by many different organizations. The on-demand database service may employ a multi-tenant approach, a virtualized approach, or any other type of database approach. On-demand database services are discussed in greater detail with reference to FIGS. 9A and 9B.

FIG. 9B shows a system diagram further illustrating an example of architectural components of an on-demand database service environment, in accordance with some implementations. The pod 944 may be used to render services to a user of the on-demand database service environment 900. In some implementations, each pod may include a variety of servers and/or other systems. The pod 944 includes one or more content batch servers 964, content search servers 968, query servers 982, file servers 986, access control system (ACS) servers 980, batch servers 984, and app servers 988. Also, the pod 944 includes database instances 990, quick file systems (QFS) 992, and indexers 994. In one or more implementations, some or all communication between the servers in the pod 944 may be transmitted via the switch 936.

In some implementations, the app servers 988 may include a hardware and/or software framework dedicated to the execution of procedures (e.g., programs, routines, scripts) for supporting the construction of applications provided by the on-demand database service environment 900 via the pod 944. In some implementations, the hardware and/or software framework of an app server 988 is configured to cause performance of services described herein, including performance of one or more of the operations of methods described herein with reference to FIGS. 1-7. In alternative implementations, two or more app servers 988 may be included to cause such methods to be performed, or one or more other servers described herein can be configured to cause part or all of the disclosed methods to be performed.

The content batch servers 964 may handle requests internal to the pod. These requests may be long-running and/or not tied to a particular customer. For example, the content batch servers 964 may handle requests related to log mining, cleanup work, and maintenance tasks.

The content search servers 968 may provide query and indexer functions. For example, the functions provided by the content search servers 968 may allow users to search through content stored in the on-demand database service environment.

The file servers 986 may manage requests for information stored in the file storage 998. The file storage 998 may store information such as documents, images, and basic large objects (BLOBs). By managing requests for information using the file servers 986, the image footprint on the database may be reduced.

The query servers 982 may be used to retrieve information from one or more file systems. For example, the query system 982 may receive requests for information from the app servers 988 and then transmit information queries to the NFS 996 located outside the pod.

The pod 944 may share a database instance 990 configured as a multi-tenant environment in which different organizations share access to the same database. Additionally, services rendered by the pod 944 may call upon various hardware and/or software resources. In some implementations, the ACS servers 980 may control access to data, hardware resources, or software resources.

In some implementations, the batch servers 984 may process batch jobs, which are used to run tasks at specified times. Thus, the batch servers 984 may transmit instructions to other servers, such as the app servers 988, to trigger the batch jobs.

In some implementations, the QFS 992 may be an open source file system available from Sun Microsystems® of Santa Clara, Calif. The QFS may serve as a rapid-access file system for storing and accessing information available within the pod 944. The QFS 992 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 968 and/or indexers 994 to identify, retrieve, move, and/or update data stored in the network file systems 996 and/or other storage systems.

In some implementations, one or more query servers 982 may communicate with the NFS 996 to retrieve and/or update information stored outside of the pod 944. The NFS 996 may allow servers located in the pod 944 to access information to access files over a network in a manner similar to how local storage is accessed.

In some implementations, queries from the query servers 922 may be transmitted to the NFS 996 via the load balancer 928, which may distribute resource requests over various resources available in the on-demand database service environment. The NFS 996 may also communicate with the QFS 992 to update the information stored on the NFS 996 and/or to provide information to the QFS 992 for use by servers located within the pod 944.

In some implementations, the pod may include one or more database instances 990. The database instance 990 may transmit information to the QFS 992. When information is transmitted to the QFS, it may be available for use by servers within the pod 944 without using an additional database call.

In some implementations, database information may be transmitted to the indexer 994. Indexer 994 may provide an index of information available in the database 990 and/or QFS 992. The index information may be provided to file servers 986 and/or the QFS 992.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of the implementations claimed.

It should be understood that some of the disclosed implementations can be embodied in the form of control logic using hardware and/or computer software in a modular or integrated manner. Other ways and/or methods are possible using hardware and a combination of hardware and software.

Any of the disclosed implementations may be embodied in various types of hardware, software, firmware, and combinations thereof. For example, some techniques disclosed herein may be implemented, at least in part, by computer-readable media that include program instructions, state information, etc., for performing various services and operations described herein. Examples of program instructions include both machine code, such as produced by a compiler, and files containing higher-level code that may be executed by a computing device such as a server or other data processing apparatus using an interpreter. Examples of computer-readable media include, but are not limited to: magnetic media such as hard disks, floppy disks, and magnetic tape; optical media such as flash memory, compact disk (CD) or digital versatile disk (DVD); magneto-optical media; and hardware devices specially configured to store program instructions, such as read-only memory (“ROM”) devices and random access memory (“RAM”) devices. A computer-readable medium may be any combination of such storage devices.

Any of the operations and techniques described in this application may be implemented as software code to be executed by a processor using any suitable computer language such as, for example, Java, C++ or Perl using, for example, object-oriented techniques. The software code may be stored as a series of instructions or commands on a computer-readable medium. Computer-readable media encoded with the software/program code may be packaged with a compatible device or provided separately from other devices (e.g., via Internet download). Any such computer-readable medium may reside on or within a single computing device or an entire computer system, and may be among other computer-readable media within a system or network. A computer system or computing device may include a monitor, printer, or other suitable display for providing any of the results mentioned herein to a user.

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

What is claimed is:

1. A system for creating or updating a social network group based on customer relationship management (CRM) records in an enterprise social network, the system comprising:
database system software stored on a tangible medium for at least one server of a database system in communication with a client machine and configured to host an enterprise social network, the database system software operable to:
receive, from the client machine, a first request to create or update a social network group based on a first CRM record stored as a data object in the database system;
identify one or more users associated with the first CRM record;
send information identifying the one or more users to the client machine for display in a user interface on a display of the client machine;
receive a second request in relation to creating or updating the social network group, the second request identifying at least a first user selected from the one or more users to be included as a member of the social network group; and
responsive to the second request, create or update the social network group to include at least the first user as a member, the social network group being identified by one or more data objects in the database system as being associated with the first CRM record.

2. The system of claim 1, the database system software further operable to:
identify one or more CRM records of the database system associated with the first CRM record;
send information identifying the one or more associated CRM records to the client machine for display in the user interface;
receive a third request to associate with the social network group a second CRM record selected from the identified one or more CRM records; and
associate the second CRM record with the social network group such that updates to the second CRM record are published as feed items in a group feed associated with the social network group.

3. The system of claim 2, wherein the second CRM record is associated with the first CRM record in a child-parent or a parent-child relationship in a hierarchical data model.

4. The system of claim 3, wherein the first CRM record is an account, and the second CRM record is an opportunity, a lead, a case, a contact, or a task associated with the account.

5. The system of claim 1, the database system software further operable to:
identify one or more files of the database system associated with the first CRM record;
send information identifying the one or more files to the client machine for display in the user interface;
receive a third request to associate with the social network group a first file selected from the identified one or more files; and
associate the first file with the social network group such that updates to the first file are published as feed items in a group feed associated with the social network group.

6. The system of claim 5, wherein the one or more files are attached to feed items of a record feed associated with the first CRM record.

7. The system of claim 1, wherein the social network group is associated with a group feed of the enterprise social network such that updates to the first CRM record are published as feed items in the group feed.

8. The system of claim 1, wherein the first CRM record is associated with a first topic, and the identified one or more users include users designated as experts regarding the first topic.

9. The system of claim 1, wherein the identified one or more users include users following the first CRM record.

10. The system of claim 1, wherein the identified one or more users include users having access to the first CRM record.

11. The system of claim 1, wherein the identified one or more users include a user who created or has ownership of the first CRM record.

12. The system of claim 1, the database system software further operable to:
determine that the user interface of the client machine is displaying the first CRM record.

13. A computer-implemented method for creating or updating a social network group based on customer relationship management (CRM) records in an enterprise social network, the method comprising:
receiving, at one or more servers of a database system from a client machine, a first request to create or update a social network group based on a first CRM record stored as a data object in the database system;
identifying one or more users associated with the first CRM record;
sending information identifying the one or more users to the client machine for display in a user interface on a display of the client machine;
receiving, at the one or more servers, a second request in relation to creating or updating the social network group, the second request identifying at least a first user selected from the one or more users to be included as a member of the social network group; and
responsive to the second request, creating or updating the social network group to include at least the first user as a member, the social network group being identified by one or more data objects in the database system as being associated with the first CRM record.

14. The method of claim 13, further comprising:
identifying one or more CRM records of the database system associated with the first CRM record;
sending information identifying the one or more associated CRM records to the client machine for display in the user interface;
receiving a third request to associate with the social network group a second CRM record selected from the identified one or more CRM records; and
associating the second CRM record with the social network group such that updates to the second CRM record are published as feed items in a group feed associated with the social network group.

15. The method of claim 13, further comprising:
identifying one or more files of the database system associated with the first CRM record;
sending information identifying the one or more files to the client machine for display in the user interface;
receiving a third request to associate with the social network group a first file selected from the identified one or more files; and
associating the first file with the social network group such that updates to the first file are published as feed items in a group feed associated with the social network group.

16. The method of claim 13, wherein the first CRM record is associated with a first topic, and the identified one or more users include users designated as experts regarding the first topic.

17. A computer program product comprising computer-readable program code to be executed by one or more processors when retrieved from a non-transitory computer-readable medium, the program code including instructions configured to cause:
receiving, at one or more servers of a database system from a client machine, a first request to create or update a social network group based on a first CRM record stored as a data object in the database system;
identifying one or more users associated with the first CRM record;
sending information identifying the one or more users to the client machine for display in a user interface on a display of the client machine;
receiving, at the one or more servers, a second request in relation to creating or updating the social network group, the second request identifying at least a first user selected from the one or more users to be included as a member of the social network group; and
responsive to the second request, creating or updating the social network group to include at least the first user as a member, the social network group being identified by one or more data objects in the database system as being associated with the first CRM record.

18. The computer program product of claim 17, the instructions further configured to cause:
identifying one or more CRM records of the database system associated with the first CRM record;
sending information identifying the one or more associated CRM records to the client machine for display in the user interface;
receiving a third request to associate with the social network group a second CRM record selected from the identified one or more CRM records; and
associating the second CRM record with the social network group such that updates to the second CRM record are published as feed items in a group feed associated with the social network group.

19. The computer program product of claim 17, the instructions further configured to cause:
identifying one or more files of the database system associated with the first CRM record;
sending information identifying the one or more files to the client machine for display in the user interface;
receiving a third request to associate with the social network group a first file selected from the identified one or more files; and
associating the first file with the social network group such that updates to the first file are published as feed items in a group feed associated with the social network group.

20. The computer program product of claim 17, wherein the first CRM record is associated with a first topic, and the identified one or more users include users designated as experts regarding the first topic.
